(19) United States
(12) Patent Application Publication
(10) Pub. No.: US 2014/0185617 A1
(43) Pub. Date: Jul. 3, 2014

(54) METHODS AND APPARATUS TO LIMIT TRANSMISSION OF DATA TO A LOCALIZED AREA IN AN IPV6 NETWORK

(71) Applicants: Michael R. Andre, Beaverton, OR (US); C. Brendan Traw, Portland, OR (US)

(72) Inventors: Michael R. Andre, Beaverton, OR (US); C. Brendan Traw, Portland, OR (US)

(73) Assignee: INTEL CORPORATION, Santa Clara, CA (US)

(21) Appl. No.: 13/976,089

(22) PCT Filed: Dec. 20, 2011
(86) PCT No.: PCT/US2011/066098

§ 371 Date: Mar. 18, 2014

(51) Int. Cl. H04L 12/733; H04L 12/741

(52) U.S. Cl. CPC H04L 45/122; H04L 45/74
USPC 370/392

(57) ABSTRACT

Methods and apparatus are disclosed for limiting transmission of data to a localized area in a networked environment. A method according to one embodiment includes receiving a request to transmit data from a source device to a sink device. If the data to be transmitted is localized data, a hop value associated with the data is set to a first predetermined value. If the data to be transmitted is not localized data, a hop value associated with the data is set to a second predetermined value.

### FIELD

The present disclosure relates to data transmission restriction, and more particularly, to methods and apparatus to limit transmission of data to a localized area in an internet protocol version 6 (IPV6) network.

### BACKGROUND

As copyrighted materials (e.g., movies, music, books, etc.) become increasingly available in digital form that are easily reproducible at higher quality levels, methods for protecting these materials from unauthorized access are needed. One existing solution, Digital Transmission Content Protection (DTCP), provides a protocol in which various cryptographic techniques are employed to prevent unauthorized copying and distribution of digital content.

In DTCP, copy control information (CCI) is carried by the digital content. The CCI specifies the conditions for copying the associated content. For example, digital content may be classified by the CCI such that (a) the content may be freely copied (no authentication required to access the content and no encryption needed to transmit the content), (b) the content may never be copied, or (c) one generation of copies may be made of the content and then classified as (d) no more copies. To access digital content protected by DTCP, a device must be authorized (i.e., have access to the decryption key(s) used to unlock the content). If an authorized device is instructed to copy the digital content, the authorized device will read the CCI information and abide by the criteria set therein. Thus, the CCI information ensures that all DCTP content carries a set of rules governing reproduction of that content, which has the effect of preventing pirates from purchasing one legitimate copy of copyrighted content and then making multiple unauthorized copies.

Although DTCP provides methods for controlling distribution and copying of digital content, it is often desirable to permit an authorized licensee of digital content to transfer that content from one device to another within a home or local area network. Home networks are typically connected to the internet, however, which raises the possibility of unauthorized transfer of this content outside of the home network to other home networks.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system diagram of a networked environment consistent with an exemplary embodiment of the present disclosure;

FIG. 2 illustrates an IPV6 header consistent with an exemplary embodiment of the present disclosure;

FIG. 3 illustrates a block diagram of one exemplary embodiment consistent with the present disclosure;

FIG. 4 illustrates a flowchart of operations of one exemplary embodiment consistent with the present disclosure;

FIG. 5 illustrates a block diagram of another exemplary embodiment consistent with the present disclosure;

FIG. 6 illustrates a flowchart of operations of another exemplary embodiment consistent with the present disclosure; and

FIG. 7 illustrates a block diagram of a processing system in an exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems and methods for allowing the distribution and copying of protected digital content within a home or local area IP network using IPV6 while preventing distribution of that content beyond the home via the internet. This distribution control may be accomplished by selectively adjusting the HOP LIMIT field in the IPV6 packet header in response to determining the protection status of the content of the packet.

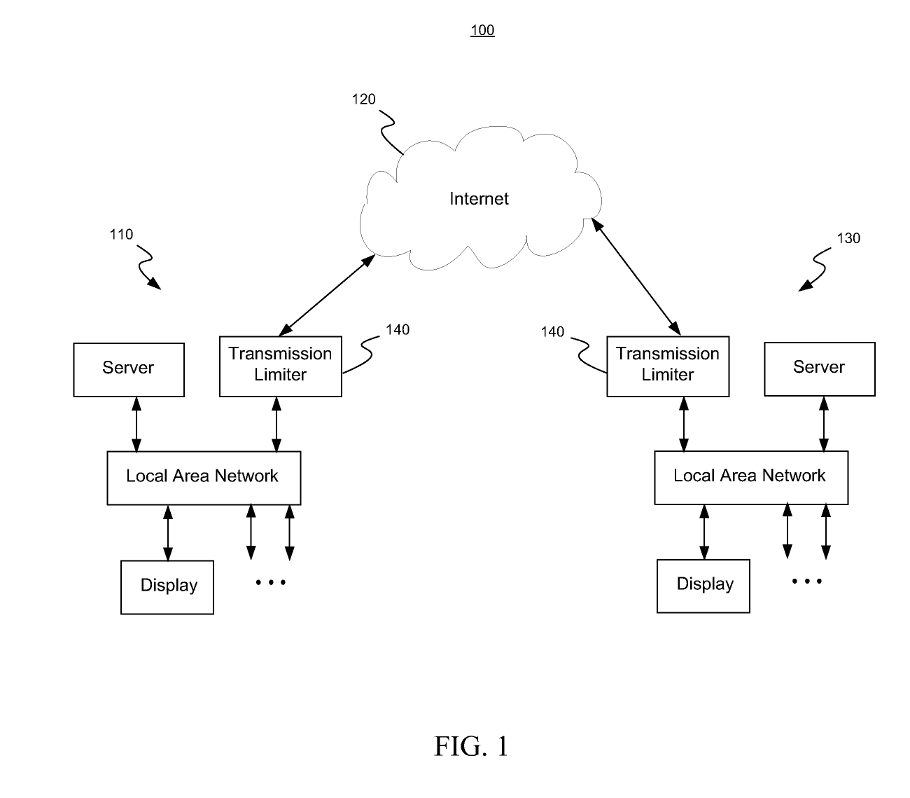

FIG. 1 illustrates a system diagram 100 of a networked environment consistent with an exemplary embodiment of the present disclosure. In the illustrated example, a first home network 110 is coupled to a second home network 130 via the internet 120. A transmission limiter 140, the operation of which is explained in greater detail below, is deployed between each home network 110, 130 and the internet 120. If the first home network 110 is authorized to access localized content, it is desirable for that content to be freely routed within the confines of the home network 110. However, it is not desirable to permit the localized content to be transmitted to the second home network 130 for unauthorized consumption. As used herein, localized content refers to any data and/or instruction wherein the distribution or transmission of that data and/or instruction is intended to be limited to a local area of a networked environment. Localized data can be proprietary or public, restricted or unrestricted. For example, it is desirable to ensure a UPnP (universal plug and play) command issued in one home network does not reach a second home network where it can cause an unwanted effect (e.g., a command to turn on the television in one house turns on a television in a neighbor's house). Therefore, a UPnP instruction may be localized data since transmission of the UPnP instruction is intended to be limited to the local (e.g., home) network. As another example, localized data may comprise a digital movie wherein it is desirable to prevent transmission of the movie beyond the boundary of a home network.

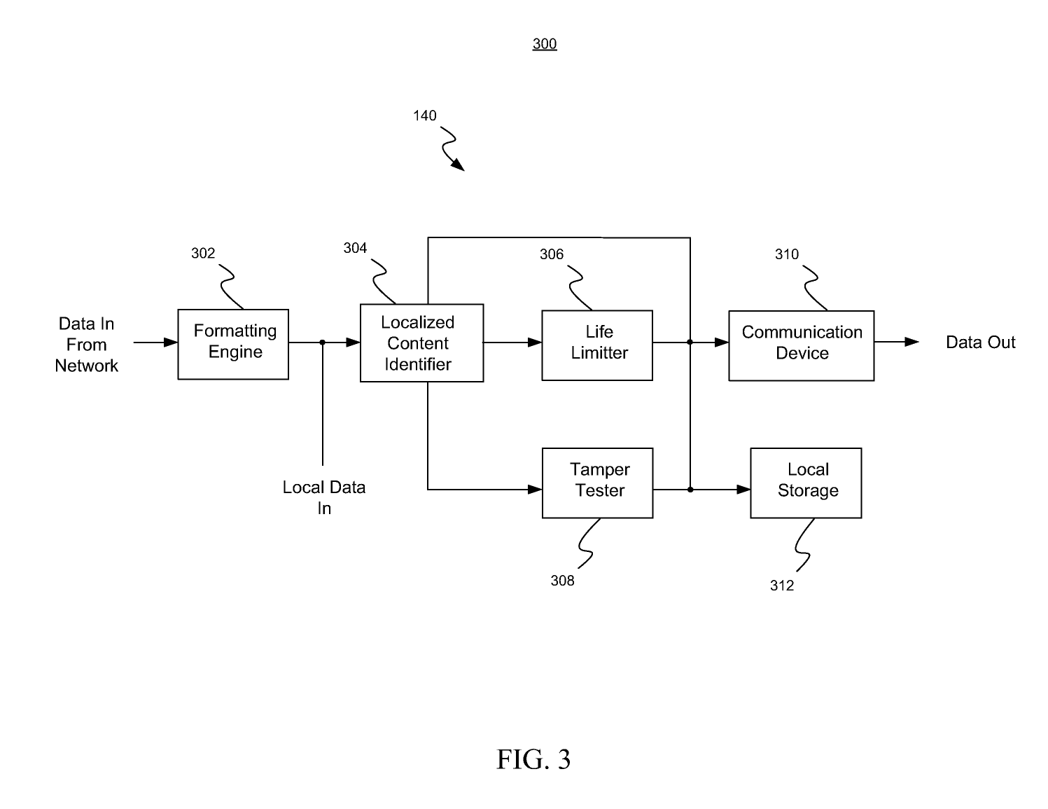

An example apparatus 50 to limit exchange of localized data is shown in FIG. 3. Transmission limiter 140 limits transmission of localized data to a localized area of the network, for example, to the home networks 110, 130 in which the transmission limiter 140 is deployed. For purposes of discussion that follows, it will be assumed that the transmission limiter 140 is located in the first home network 110, the first home network 110 is authorized to access the localized content, and the second home network 130 is not authorized to access the localized content.

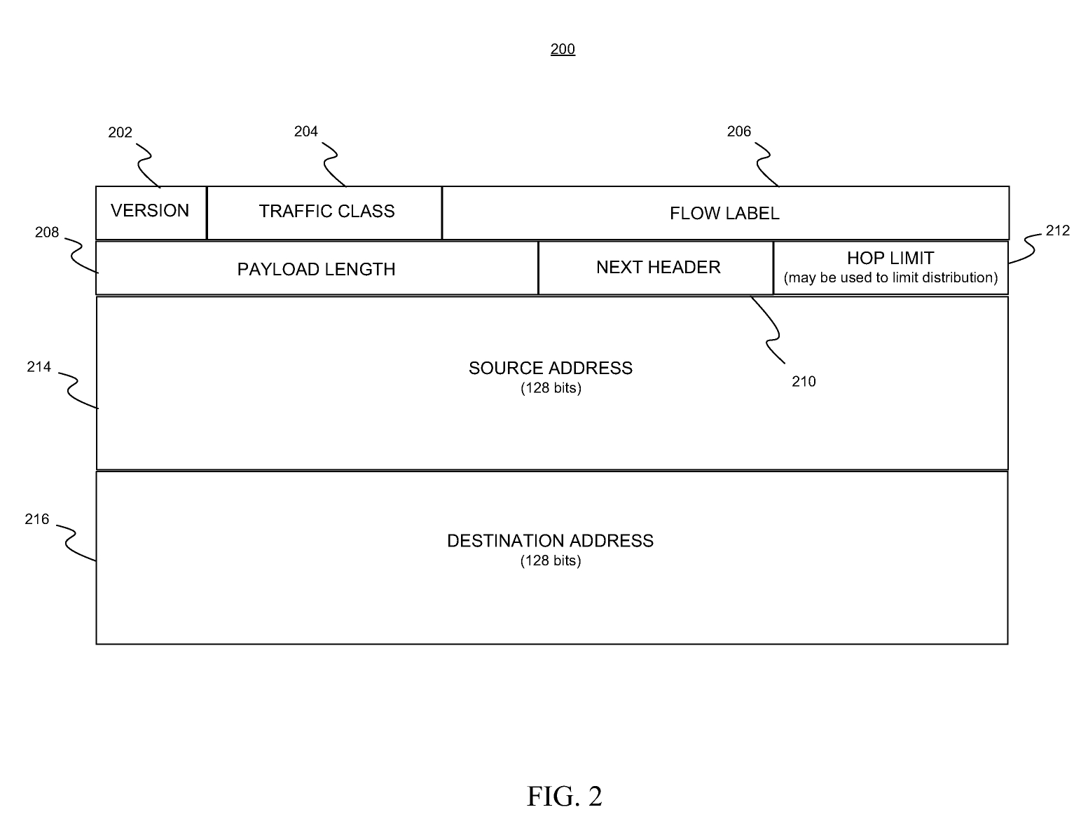

FIG. 2 illustrates an IPV6 header 200 consistent with an exemplary embodiment of the present disclosure. With IPV6, for example, when a source device transmits data, the data is typically formatted into a datagram that includes one or more independent packets. Each packet is treated independently by the routers/switches in the IP network, such that the packets in a datagram transmitted from a source device (transmitting device) to a sink device (receiving device) may be separated and routed through different channels and reassembled at the sink device. Therefore, each packet must contain the addressing information necessary to route the packet to the intended sink device. To this end, each packet is provided with an IPV6 header 200 as shown in FIG. 2. Every IP packet is structured to include an IPV6 header 200 followed by a data field.

The IPV6 header 200 typically includes a number of fields including a version field 202, a traffic class field 204, a flow label field 206, a payload length field 208, a next header field 210, a hop limit field 212, a source address field 214 and a destination address field 216. The source and destination address fields 214, 216 are each 128 bits long and thus permit an IP address space of up to 2¹²⁸ (or approximately 3.4×10³⁸) device addresses.

The hop limit field 212 is used to ensure that undeliverable packets transmitted through the Internet do not eternally flow from router to router thereby reducing Internet performance. In particular, the hop limit field 212 is set to a value indicating the maximum life that the associated packet may have in the Internet. When a packet is handled by a router or switch (as used herein the terms router, switch, and router/switch are interchangeable), operating in accordance with IPV6 protocol, the router/switch reduces the value appearing in the hop limit field 212 of the header 200 by one. If a router/switch receives a packet having a value in the hop limit field 212 that is equal to zero, it destroys the packet. This technique ensures that undeliverable IP packets do not congest the network in the event of routing loops caused, for example, by corrupted routing tables. The value in the hop limit field 212 may be thought of as a measure of the number of IP routers/switches that may handle a packet before it is assumed undeliverable and destroyed. Typically, the hop limit field 212 is set to a value of 30 or higher. The transmission limiter 140, however, may use the hop limit field 212 for the purpose of limiting exchange of localized data to a localized area of the network as will be explained in greater detail below.

FIG. 3 illustrates a block diagram 300 of one exemplary embodiment consistent with the present disclosure. Shown is an example implementation of transmission limiter 140 to limit exchange of localized data to a localized area of the network, for example, to the home networks 110, 130 in which the transmission limiter 140 is deployed.

Transmission limiter 140 comprises a formatting engine 302 which responds to a request to send data over an IPV6 based network by developing an Internet datagram including one or more IPV6 headers 200. The formatting engine 302 populates the various fields in the header including the hop limit field 212 which may receive a standard value sufficient to ensure that a deliverable packet will reach any destination on the Internet (e.g., 30), but that undeliverable packets will be implicitly identified and destroyed in a reasonable length of time.

In order to determine if the data to be transmitted is localized data, the transmission limiter 140 is further provided with a localized content identifier 304. The localized content identifier 304 may identify localized content by, for example, reading a code associated with the data to be transmitted. For instance, if the data to be transmitted is protected by DTCP, the localized content identifier 304 may determine the classification of the content by reading the CCI code. Of course, other encoding schemes may be employed to designate localized content. For example, localized content may be packaged to include a header that designates the protection level of the content (e.g., ranging from “one use” to “freely copy”).

Irrespective of the precise mechanism chosen to identify localized content, if the localized content identifier 304 identifies the content to be transmitted as unrestricted to the local network, then it forwards the packet(s) associated with that content to a communication device 310 (e.g., a modem, etc.) for transmission via the network (e.g., the internet 120). If, on the other hand, the localized content identifier 304 identifies the content to be transmitted as localized (i.e., restricted to transmission within a local area of the network), instead of routing the data immediately to the network via the communication device 310, it permits a life limiter 306 to process the data.

The life limiter 306 sets the hop limit field 212 associated with the localized data to a value which limits the number of IP routers/switches that may handle the localized data before the localized data is destroyed to a level that substantially precludes exchange of the localized data between the source device in the home network 110 and a sink device in a second home network (e.g., network 130). As discussed above, the formatting engine 302 sets the hop limit field 212 in the IPV6 header(s) 200 associated with the datagram carrying the localized data to the normal value (e.g., thirty) for standard Internet transmission of data whose transmission area is not restricted. If the localized content identifier 304 identifies the content to be transmitted as localized data, the life limiter 306 reduces the value in the hop limit field 212 to a level lower than that required for standard Internet transmission to thereby substantially limit transmission of the localized data to a local area of the network (e.g., the home network 110).

The topology of IP based home networks is relatively simple when compared to the topology of the Internet. Specifically, the number of routers/switches that a packet traverses to move between two devices in the typical home network is significantly lower than the number of routers/switches a packet traverses to move between two end points on the Internet. Typical home networks have fewer than five IP routers/switches. More than five IP routers/switches, however, are usually required to traverse an Internet path between homes (even when the two homes are served by the same Internet Service Provider and are in the same geographic area). Therefore, if the life limiter 306 sets the hop limit field 212 of packet(s) carrying localized data to, for example, five, the localized data packet(s) will be destroyed by the IP routers/switches before they can reach an intended destination in a second home network 130.

In particular, as stated above, IP routers/switches are currently designed to reduce the value stored in the hop limit field 212 in the IPV6 headers 200 they process by one, and to destroy any packet they encounter which has a hop limit value equal to zero. Therefore, after the life limiter 306 sets the value stored in the hop limit field 212 of the IP packet(s) associated with the localized content to the reduced level discussed above (e.g., five), the communication device 310 is permitted to freely transmit the packet(s) toward whatever destination address has been specified by the user. If the destination address is outside a localized area (e.g., the home network 110), the packet(s) carrying the localized data will be destroyed by the IP routers/switches pursuant to their normal behavior before those packets reach their intended destination as a result of their reduced hop limit settings. If, however, the intended destination is within the localized area (e.g., the home network 110), the packet(s) carrying the localized data will reach their intended destination before expiration of the reduced hop limit As a result, localized data can be freely transferred within the localized area (e.g., the home network 110), but is automatically destroyed if sent beyond the boundary of the localized area (e.g., beyond the home network 110).

To enhance the effectiveness of the system, the transmission limiter 140 is further provided with a tamper tester 308. Whenever the transmission limiter 140 receives data packet(s) from the network, those packet(s) are reviewed by the localized content identifier 304 to determine if they contain localized data. If the packet(s) do not contain localized data, they are saved in a local storage device 312 in the normal manner for further processing by local receiving devices (e.g., a television). If, however, the packet(s) do contain localized data, the tamper tester 308 reviews their hop limit fields 212 to determine if those fields have been subjected to tampering. This determination may be made, for example, by comparing the hop limit fields 212 of the received packets to a threshold value such as the predetermined hop limit value set by the life limiter 306 (e.g., five) for packets associated with localized content. If the hop limit values of the received packets exceed the predetermined hop limit value set by the life limiter 306 (e.g., five), the hop limit fields 212 have been subjected to tampering. Whenever the tamper tester 308 determines that tampering has occurred, it destroys the associated received data thereby frustrating the efforts of the parties involved in the tampering effort. If, however, no tampering is detected, the tamper tester 308 stores the packet(s) in the local storage device 312 in the normal manner for further processing by local receiving devices.

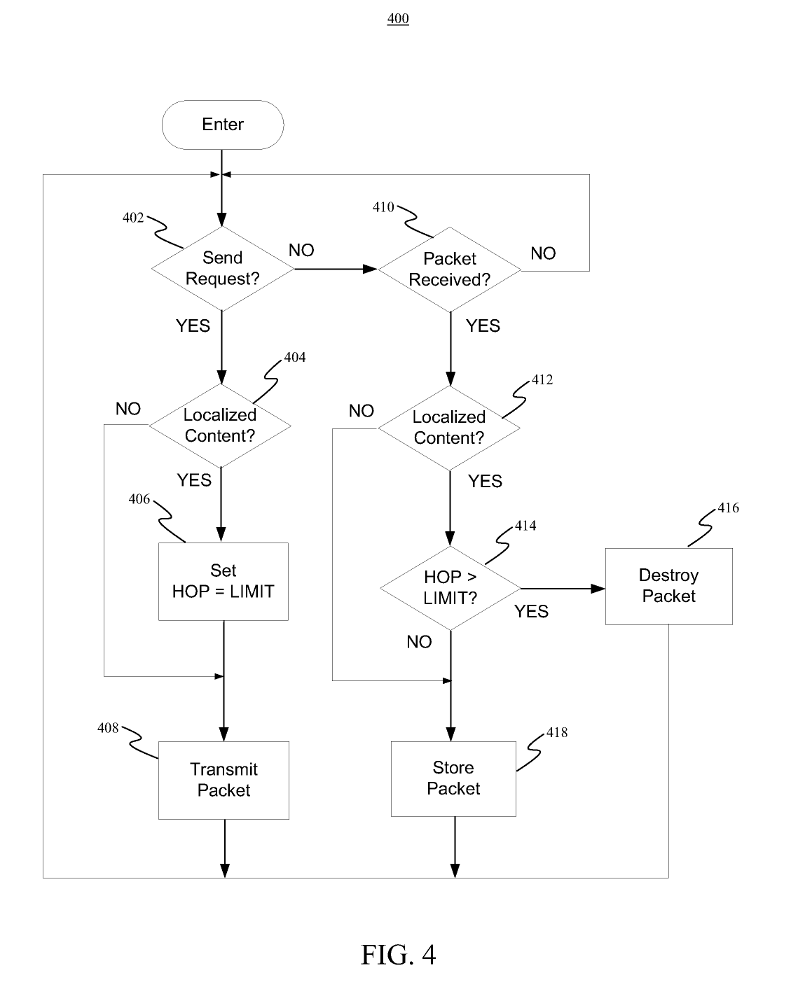

FIG. 4 illustrates a flowchart of operations 400 of one exemplary embodiment consistent with the present disclosure. At operation 402, a determination is made, for example by formatting engine 302, as to whether a request to send data has been received. If no such request has been received, a further determination is made at operation 410 as to whether a packet has been received from the network. Control continues to loop through operation 402 and 410 until a request to transmit data is received or a packet is received from the network.

Assuming that a request to send data had been received, the data is formatted by the formatting engine 302 into one or more IP packets for transmission via the network. Control then advances to operation 404 where the localized content identifier 304 determines if the data to be transmitted includes localized content. If the data includes localized content, then at operation 406 the life limiter 306 sets the hop limit field 212 of the packet to be transmitted to a predetermined value (e.g., five) which is sufficiently low to ensure that the packet will not survive long enough to reach an IP address outside of a localized area of the network (e.g., the home network) in which the source device is located. At operation 408, the packet is then transmitted and control returns to loop through operation 402 and 410.

If, however, the packet does not contain localized content, control advances directly from operation 404 to operation 408 where the packet is transmitted without adjustment to the hop limit field 212.

Assuming, next, that packets have been received from the network, control turns to operation 412 where the localized content identifier 304 determines if the received packet contains localized content. If the received packet contains localized content, then at operation 414 the tamper tester 308 compares the value stored in the hop limit field 212 of the received packet to a threshold value (e.g., five) to determine if the received packet was tampered with in an effort to frustrate the transmission limit If no tampering is detected at operation 414 the packet may be forwarded to local storage 312 for further processing and/or consumption at operation 418. If, however, tampering is detected, the packet is destroyed at operation 416. Control then returns to loop through operation 402 and 410.

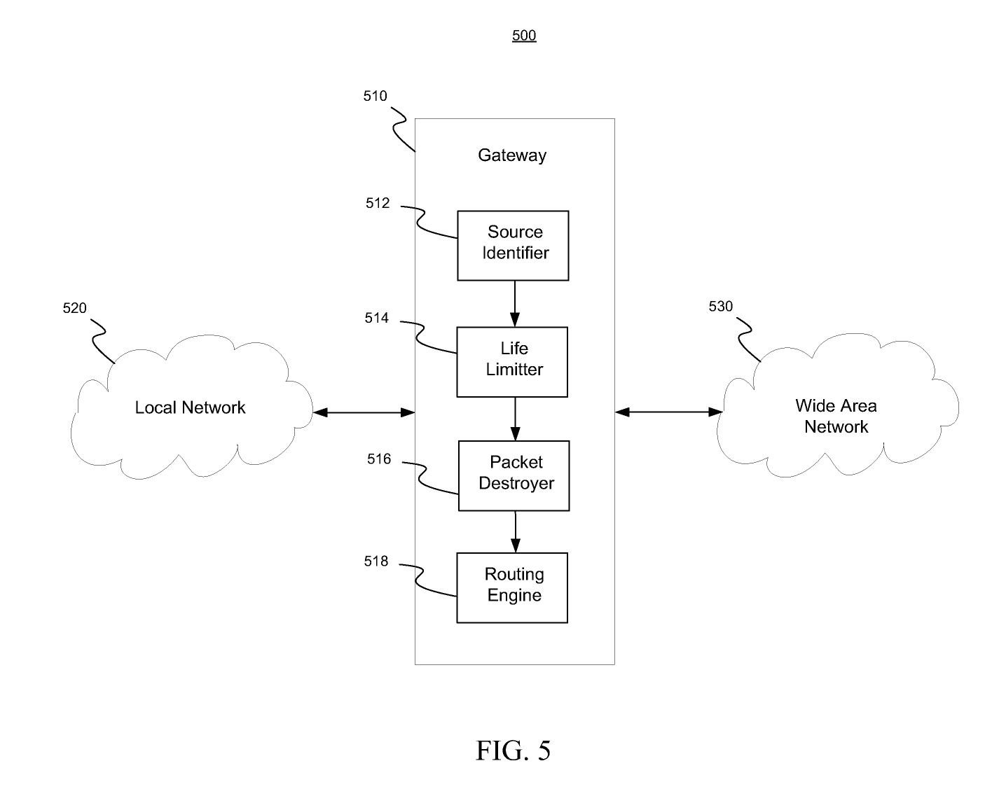

FIG. 5 illustrates a block diagram 500 of another exemplary embodiment consistent with the present disclosure. A modified router/gateway 510 is shown connecting local network 520 and wide area network 530. As discussed above, routers and/or gateways in an IPV6 based network are structured to automatically decrement the hop limit field 212 of every packet they route by one. To further enhance the reliability of the disclosed methods and apparatus, a gateway or router that couples the local network 520 (e.g., home network 110) to the wide area network 530 (e.g., the Internet 120) may be modified to decrement the hop limit field 212 of every packet received from the local network by a value greater than one. For example, the router/gateway 510 may be structured to decrement the hop limit field 212 of packets received from the local network by a value of N, where N is the expected number of routers in the average home network (e.g., five). If the packet is associated with localized data, its hop limit field 212 will have been set to a low level (e.g., five) as explained above. Thus, if selected to be large enough, the unusually large decrement of the hop limit field 212 by the gateway/router 510 will ensure that localized packets will be destroyed before entering the wide area network.

However, since non-localized packets have a normal hop limit value, and since a normal hop limit value is typically twice as large as needed for the packet to reach its intended destination, the unusually large decrementing of the nonlocalized packet by the router/gateway 510 coupling the local network 520 to the wide area network 530 will not impede delivery of the non-localized packets received from the local network. Instead, the packets associated with non-localized data will enter the wide area network and be routed to their intended destinations in the ordinary fashion.

The modified router/gateway 510 connecting the local area network to the wide area network may be structured to decrement the hop limit field 212 of packets traveling to the local area network from the wide area network by the conventional amount (e.g., one). Thus, the modified router/gateway 510 would apply a different decrement to the hop limit field 212 of received packets depending upon their point of origin (e.g., the local network or the wide area network) or direction of travel (e.g., into the local network versus out of the local network).

The modified router/gateway 510 includes a source identifier 512 which operates to determine if a packet received at the gateway originated in the local network 520 or the wide area network 530. It also includes a life limiter 514 which responds to the source identifier 512 by decrementing the hop limit field 212 by a first value if the packet originated in the local network 520 and a second value if the packet originated in the wide area network 530. A packet destroyer 516 reviews the hop limit field 212 and destroys the packet if the value falls to zero. A routing engine 518 routes the packets having a non-zero value in their hop limit field 212 in accordance with IPV6 protocol.

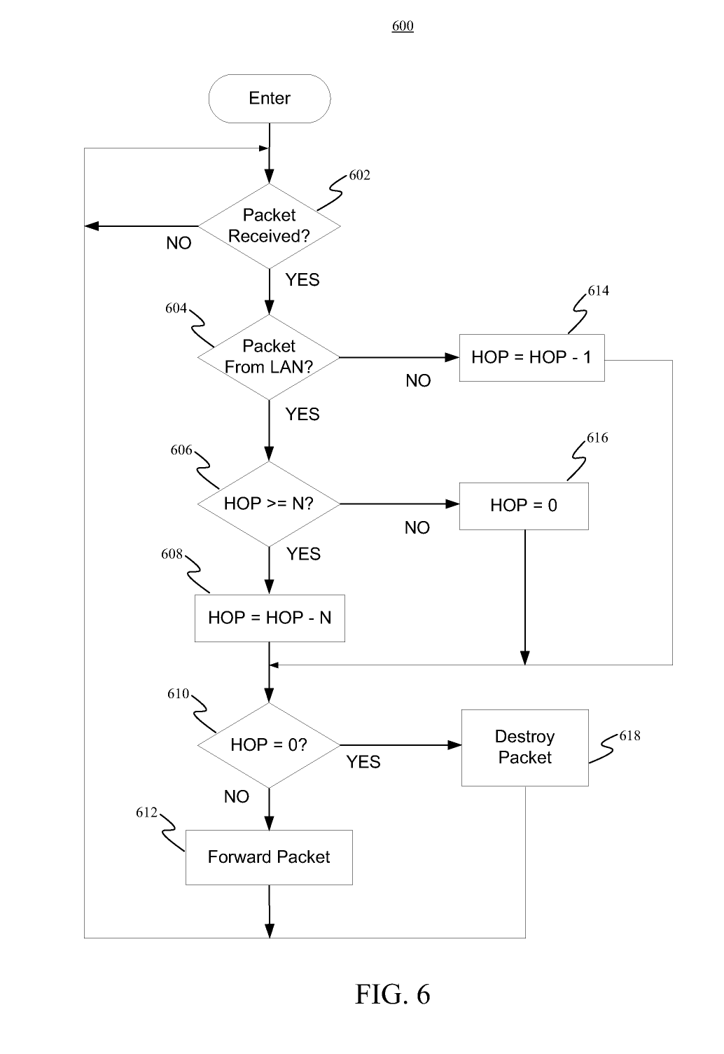

FIG. 6 illustrates a flowchart of operations 600 of another exemplary embodiment consistent with the present disclosure. At operation 602, control is looped until a packet is received. At operation 604, once a packet has been received, a determination is made as to whether it came from the local network. If the packet was received from the wide area network, the life limiter 514 decrements the hop limit field 212 by one at operation 614. If the packet was received from the local network, the life limiter 514 determines if the hop limit field 212 of the received packet contains a value that is less than N at operation 606. If so, the life limiter 514 reduces the value in the hop limit field 212 to zero at operation 616 and control advances to operation 610. Otherwise, if the value in the hop limit field 212 is greater than or equal to N, the life limiter 514 decrements the value in the hop limit field 212 of the packet by the value N at operation 608. The value N can be any desired value greater than one (e.g., five) but small enough to not interfere with the transmission of non-localized data.

After the hop limit field 212 is decremented by an appropriate amount, at operation 610 the packet destroyer 516 of the gateway examines the hop limit field 212 associated with the packet. If the value stored in the hop limit field 212 is equal to zero, the packet destroyer 516 destroys the packet at operation 618. If the value in the hop limit field 212 is not equal to zero, the routing engine 518 forwards the packet to another gateway/router/switch or the destination address identified in the packet header in accordance with the Internet Protocol at operation 612. Control is returned to operation 602.

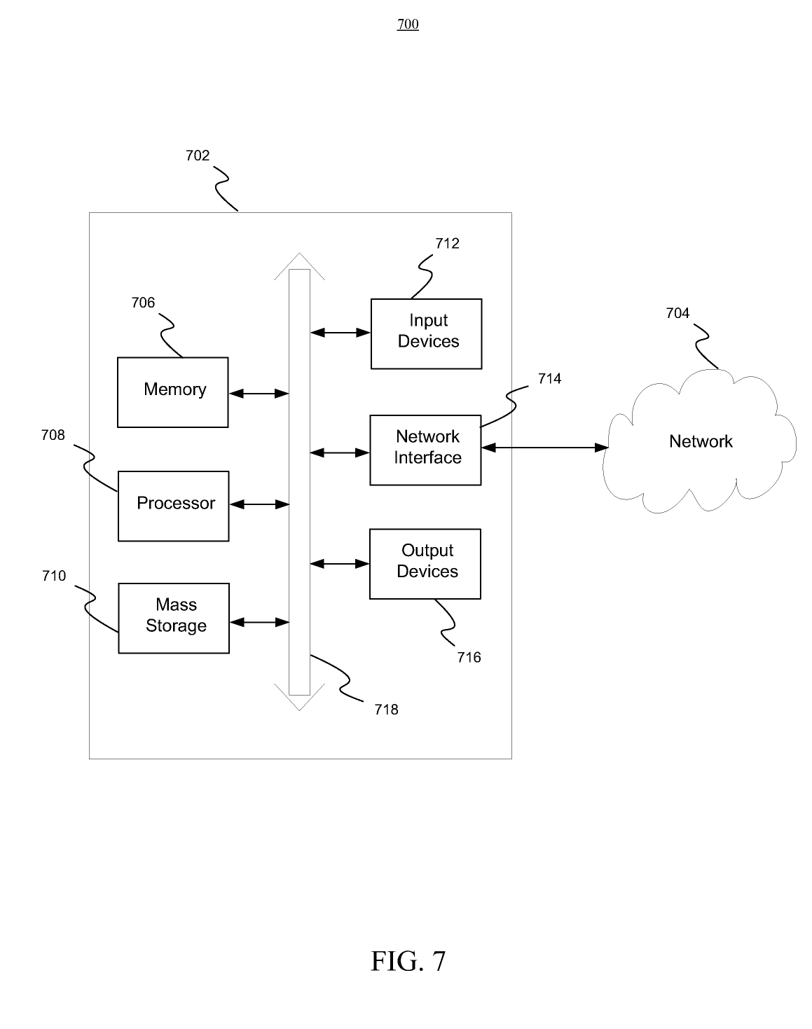

FIG. 7 illustrates a block diagram 700 of a processing system in an exemplary embodiment consistent with the present disclosure. An example computer system 702 is shown communicating with a network 704. The computer system 702 is capable of implementing the apparatus and methods disclosed herein. The computer 702 can be, for example, a server, a personal computer, a tablet computer, smart phone, smart device, a personal digital assistant (PDA), an Internet appliance, a DVD player, a CD player, a digital video recorder, a personal video recorder, a set top box, or any other type of computing device. The computer system 702 of the instant example includes a processor 708. For example, the processor 708 can be implemented by one or more Intel® microprocessors from the Pentium® family, the Itanium® family or the XScale® family. Of course, other processors from other families are also appropriate. The processor 708 may communicate with memory 706, mass storage 710, input devices 712, output devices 716 and network interface 714. In some embodiments the communication may take place through a bus 718.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-21. (canceled)

22. A method, comprising:
responding to a request to transmit data from a source device to a sink device by determining if said data to be transmitted is localized data;
setting a hop limit parameter in an internet protocol version 6 (IPV6) header associated with said data to a first predetermined value approximately equal to a number of routers expected in a home network, if said data is localized data; and
transmitting said IPV6 header and said data from said source device toward said sink device via a network.

23. The method of claim 22, further comprising setting said hop limit parameter in said IPV6 header associated with said data to a second predetermined value selected to permit transmission of said data throughout a wide area network, if said data is not localized data.

24. The method of claim 22, wherein said source device is located in a first home network and said sink device is located in a second home network.

25. The method of claim 22, wherein said first predetermined value is in the range of four to six.

26. The method of claim 23, wherein said second predetermined value is greater than or equal to thirty.

27. The method of claim 22, wherein said data is protected by Digital Transmission Content Protection (DTCP).

28. The method of claim 27, wherein said determination of localized data is based on
copy control information (CCI) associated with said DTCP.

29. A method, comprising:
receiving an IPV6 header and associated data at a sink device from a source device via a network;
determining if said data is localized data;
comparing a hop limit parameter in said IPV6 header to a predetermined value; and
destroying said IPV6 header and said data if said hop limit parameter is greater than said predetermined value and said data is localized data.

30. The method of claim 8, wherein said source device is located in a first home network and said sink device is located in a second home network.

31. The method of claim 29, wherein said predetermined value is in the range of four to six.

32. The method of claim 29, wherein said data is protected by Digital Transmission Content Protection (DTCP).

33. The method of claim 32, wherein said determination of localized data is based on
copy control information (CCI) associated with said DTCP.

34. At least one computer accessible medium storing instructions which, when executed by a machine, cause the machine to:
respond to a request to transmit data from a source device to a sink device by determining if said data to be transmitted is localized data;
set a hop limit parameter in an internet protocol version 6 (IPV6) header associated with said data to a first predetermined value approximately equal to a number of routers expected in a home network, if said data is localized data; and
transmit said IPV6 header and said data from said source device toward said sink device via a network.

35. The computer accessible medium of claim 34, wherein the instructions further cause the machine to set said hop limit parameter in said IPV6 header associated with said data to a second predetermined value selected to permit transmission of said data throughout a wide area network, if said data is not localized data.

36. The computer accessible medium of claim 34, wherein said source device is located in a first home network and said sink device is located in a second home network.

37. The computer accessible medium of claim 34, wherein said first predetermined value is in the range of four to six.

38. The computer accessible medium of claim 35, wherein said second predetermined value is greater than or equal to thirty.

39. The computer accessible medium of claim 34, wherein said data is protected by Digital Transmission Content Protection (DTCP).

40. The computer accessible medium of claim 39, wherein said determination of localized data is based on copy control information (CCI) associated with said DTCP.

41. An apparatus comprising:
localized content identifier circuitry configured to respond to a request to transmit data from a source device to a sink device by determining if said transmit data is localized data;
life limiter circuitry configured to set a hop limit parameter in an internet protocol version 6 (IPV6) transmit header associated with said transmit data to a first predetermined value approximately equal to a number of routers expected in a home network, if said transmit data is localized data; and
communication circuitry configured to transmit said IPV6 transmit header and said transmit data from said source device toward said sink device via a network.

42. The apparatus of claim 41 further comprising:
tamper detection circuitry configured to receive an IPV6 receive header and associated receive data via said network, determine if said receive data is localized data, compare a hop limit parameter in said IPV6 receive header to said first predetermined value, and destroy said IPV6 receive header and said receive data if said hop limit parameter in said IPV6 receive header is greater than said first predetermined value and said receive data is localized data.

43. The apparatus of claim 41, wherein said hop limit parameter in said IPV6 transmit header is set to a second predetermined value selected to permit transmission of said transmit data throughout a wide area network, if said transmit data is not localized data.

44. The apparatus of claim 41, wherein said source device is located in a first home network and said sink device is located in a second home network.

45. The apparatus of claim 41, wherein said first predetermined value is in the range of four to six.

46. The apparatus of claim 43, wherein said second predetermined value is greater than or equal to thirty.

47. The apparatus of claim 41, wherein said transmit data and said receive data are protected by Digital Transmission Content Protection (DTCP).

48. The apparatus of claim 47, wherein said determination of localized data is based on copy control information (CCI) associated with said DTCP.
